(19) United States
(12) Patent Application Publication
(10) Pub. No.: US 2026/0231074 A1
(43) Pub. Date: Aug. 6, 2026

(54) CANDIDATE CELL TIMING ADVANCE GROUP MANAGEMENT IN CONDITIONAL LOWER-LAYER TRIGGERED MOBILITY

(71) Applicant: QUALCOMM Incorporated, San Diego, CA (US)

(72) Inventors: Doohyun SUNG, Basking Ridge, NJ (US); Changhwan PARK, San Diego, CA (US); Jelena DAMNJANOVIC, Del Mar, CA (US)

(21) Appl. No.: 19/455,463

(22) Filed: Jan. 21, 2026

Related U.S. Application Data
(60) Provisional application No. 63/754,337, filed on Feb. 5, 2025.

(51) Int. Cl. H04W 56/00; H04W 72/231; H04W 74/0833

(52) U.S. Cl. CPC H04W 56/0045; H04W 72/231; H04W 74/0833

(57) ABSTRACT

Methods, systems, and devices for wireless communications are described. A user equipment (UE) may receive, from a serving cell, control signaling indicating a candidate cell timing advance group (C-TAG) including multiple candidate cells. The UE may receive, from the serving cell, a downlink control message including a command to initiate access with a candidate cell of the multiple candidate cells of the C-TAG. The UE may transmit, to the candidate cell, a random access channel (RACH) message based on the command to initiate access with the candidate cell. The candidate cell may transmit, to the serving cell, a report including a timing advance (TA) based on the RACH message. The UE may obtain a common TA associated with the C-TAG based on transmitting the RACH message. The UE may communicate with at least one candidate cell of the multiple candidate cells of the C-TAG based on the common TA.

### CROSS REFERENCES

The present Application for Patent claims benefit of U.S. Provisional Patent Application No. 63/754,337 by SUNG et al., entitled “CANDIDATE CELL TIMING ADVANCE GROUP MANAGEMENT IN CONDITIONAL LOWER-LAYER TRIGGERED MOBILITY,” filed Feb. 5, 2025, assigned to the assignee hereof, and hereby expressly incorporated by reference herein in its entirety as if fully set forth below and for all applicable purposes.

### FIELD OF TECHNOLOGY

The following relates to wireless communications, including candidate cell timing advance group (C-TAG) management in conditional lower-layer triggered mobility (LTM).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some cases, UEs may handover from a source cell to a candidate cell via conditional lower-layer triggered mobility (LTM).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a serving cell, control signaling indicating a candidate cell TA group (C-TAG) including a set of multiple candidate cells, receiving, from the serving cell, a downlink control message including a command to initiate access with a candidate cell of the set of multiple candidate cells of the C-TAG, transmitting, to the candidate cell, a random access channel (RACH) message based on the command to initiate access with the candidate cell, obtaining a common timing advance (TA) associated with the C-TAG based on transmitting the RACH message, and communicating with at least one candidate cell of the set of multiple candidate cells of the C-TAG based on the common TA.

A UE for wireless communications is described. The UE may include one or more memories storing processor executable code, and one or more processors coupled with the one or more memories. The one or more processors may individually or collectively be operable to execute the code to cause the UE to receive, from a serving cell, control signaling indicating a C-TAG including a set of multiple candidate cells, receive, from the serving cell, a downlink control message including a command to initiate access with a candidate cell of the set of multiple candidate cells of the C-TAG, transmit, to the candidate cell, a RACH message based on the command to initiate access with the candidate cell, obtain a common TA associated with the C-TAG based on transmitting the RACH message, and communicate with at least one candidate cell of the set of multiple candidate cells of the C-TAG based on the common TA.

Another UE for wireless communications is described. The UE may include means for receiving, from a serving cell, control signaling indicating a C-TAG including a set of multiple candidate cells, means for receiving, from the serving cell, a downlink control message including a command to initiate access with a candidate cell of the C-TAG, means for transmitting, to the candidate cell, a RACH message based on the command to initiate access with the candidate cell, means for obtaining a common TA associated with the C-TAG based on transmitting the RACH message, and means for communicating with at least one candidate cell of the set of multiple candidate cells of the C-TAG based on the common TA.

A non-transitory computer-readable medium storing code for wireless communications is described. The code may include instructions executable by one or more processors to receive, from a serving cell, control signaling indicating a C-TAG including a set of multiple candidate cells, receive, from the serving cell, a downlink control message including a command to initiate access with a candidate cell of the set of multiple candidate cells of the C-TAG, transmit, to the candidate cell, a RACH message based on the command to initiate access with the candidate cell, obtain a common TA associated with the C-TAG based on transmitting the RACH message, and communicate with at least one candidate cell of the set of multiple candidate cells of the C-TAG based on the common TA.

In some examples of the method, UEs, and non-transitory computer-readable medium described herein, obtaining the common TA may include operations, features, means, or instructions for receiving, from the serving cell, second control signaling indicating the common TA associated with the C-TAG based on the candidate cell being associated with the C-TAG.

Some examples of the method, UEs, and non-transitory computer-readable medium described herein may further include operations, features, means, or instructions for resetting a validation timer associated with the common TA based on receiving the second control signaling.

In some examples of the method, UEs, and non-transitory computer-readable medium described herein, obtaining the common TA may include operations, features, means, or instructions for determining the common TA based on one or more TAs associated with one or more candidate cells of the C-TAG.

In some examples of the method, UEs, and non-transitory computer-readable medium described herein, obtaining the common TA may include operations, features, means, or instructions for measuring an individual TA associated with the candidate cell, where the common TA may be based on the individual TA associated with the candidate cell.

In some examples of the method, UEs, and non-transitory computer-readable medium described herein, the control signaling indicating the C-TAG further indicates a C-TAG identifier, candidate cell identifiers of the set of multiple candidate cells, one or more reference signal received power (RSRP) change thresholds for evaluating a validity of the common TA, one or more validation timers associated with the common TA, or any combination thereof.

In some examples of the method, UEs, and non-transitory computer-readable medium described herein, the one or more validation timers include a single validation timer associated with the set of multiple candidate cells, or a set of multiple validation timers, each validation timer of the set of multiple validation timers associated with one or more respective candidate cells of the set of multiple candidate cells.

Some examples of the method, UEs, and non-transitory computer-readable medium described herein may further include operations, features, means, or instructions for performing measurements for reference signals received via one or more candidate cells of the set of multiple candidate cells and determining a validity of the common TA based on a comparison between the measurements and one or more RSRP change thresholds associated with the C-TAG, where communicating with the at least one candidate cell may be based on the validity of the common TA.

In some examples of the method, UEs, and non-transitory computer-readable medium described herein, the one or more RSRP change thresholds include a single RSRP change threshold associated with the set of multiple candidate cells, or a set of multiple RSRP thresholds, each RSRP threshold of the set of multiple RSRP thresholds associated with one or more respective candidate cells of the set of multiple candidate cells.

In some examples of the method, UEs, and non-transitory computer-readable medium described herein, the one or more RSRP change thresholds may be associated with a reference candidate cell of the set of multiple candidate cells.

Some examples of the method, UEs, and non-transitory computer-readable medium described herein may further include operations, features, means, or instructions for determining one or more validities of one or more individual TAs associated with one or more candidate cells of the C-TAG based on expiration of a validation timer associated with the common TA, measurements of reference signals received from one or more candidate cells exceeding a measurement change threshold, or both and determining a validity of the common TA based on the one or more validities of the one or more individual TAs satisfying a threshold.

Some examples of the method, UEs, and non-transitory computer-readable medium described herein may further include operations, features, means, or instructions for determining an invalidity of the common TA and transmitting, to the serving cell, a report indicating the invalidity of the common TA, where the report includes a C-TAG identifier, an indication of a first subset of candidate cells of the set of multiple candidate cells that may be associated with valid individual TAs, an indication of a second subset of candidate cells of the set of multiple candidate cells that may be associated with invalid individual TAs, an indication of the valid individual TAs associated with the first subset of candidate cells, or any combination thereof.

In some examples of the method, UEs, and non-transitory computer-readable medium described herein, the report may be transmitted based on a timer at the UE.

In some examples of the method, UEs, and non-transitory computer-readable medium described herein, the RACH message may be transmitted based on an expiration of a prohibit timer.

In some examples of the method, UEs, and non-transitory computer-readable medium described herein, the RACH message includes a C-TAG identifier of the C-TAG, a candidate cell identifier of the candidate cell, a synchronization signal block index, or any combination thereof.

In some examples of the method, UEs, and non-transitory computer-readable medium described herein, the control signaling indicating the C-TAG includes a radio resource control (RRC) message, a medium access control-control element (MAC-CE), or both.

A method for wireless communications by a serving cell is described. The method may include outputting, to a UE, control signaling indicating a C-TAG including a set of multiple candidate cells, outputting, to the UE, a downlink control message including a command to initiate access with a candidate cell of the set of multiple candidate cells of the C-TAG, obtaining, from the candidate cell of the C-TAG, a report including an indication of a common TA, and outputting, to the UE, the common TA associated with the C-TAG based on obtaining the report.

A serving cell for wireless communications is described. The serving cell may include one or more memories storing processor executable code, and one or more processors coupled with the one or more memories. The one or more processors may individually or collectively be operable to execute the code to cause the serving cell to output, to a UE, control signaling indicating a C-TAG including a set of multiple candidate cells, output, to the UE, a downlink control message including a command to initiate access with a candidate cell of the set of multiple candidate cells of the C-TAG, obtain, from the candidate cell of the C-TAG, a report including an indication of a common TA, and output, to the UE, the common TA associated with the C-TAG based on obtaining the report.

Another serving cell for wireless communications is described. The serving cell may include means for outputting, to a UE, control signaling indicating a C-TAG including a set of multiple candidate cells, means for outputting, to the UE, a downlink control message including a command to initiate access with a candidate cell of the set of multiple candidate cells of the C-TAG, means for obtaining, from the candidate cell of the C-TAG, a report including an indication of a common TA, and means for outputting, to the UE, the common TA associated with the C-TAG based on obtaining the report.

A non-transitory computer-readable medium storing code for wireless communications is described. The code may include instructions executable by one or more processors to output, to a UE, control signaling indicating a C-TAG including a set of multiple candidate cells, output, to the UE, a downlink control message including a command to initiate access with a candidate cell of the set of multiple candidate cells of the C-TAG, obtain, from the candidate cell of the C-TAG, a report including an indication of a common TA, and output, to the UE, the common TA associated with the C-TAG based on obtaining the report.

In some examples of the method, serving cells, and non-transitory computer-readable medium described herein, the control signaling indicating the C-TAG further indicates a C-TAG identifier, candidate cell identifiers of the set of multiple candidate cells, one or more RSRP change thresholds for evaluating a validity of the common TA, one or more validation timers associated with the common TA, or any combination thereof.

In some examples of the method, serving cells, and non-transitory computer-readable medium described herein, the one or more validation timers include a single validation timer associated with the set of multiple candidate cells, or a set of multiple validation timers, each validation timer of the set of multiple validation timers associated with one or more respective candidate cells of the set of multiple candidate cells.

In some examples of the method, serving cells, and non-transitory computer-readable medium described herein, the one or more RSRP change thresholds include a single RSRP change threshold associated with the set of multiple candidate cells, or a set of multiple RSRP thresholds, each RSRP threshold of the set of multiple RSRP thresholds associated with one or more respective candidate cells of the set of multiple candidate cells.

In some examples of the method, serving cells, and non-transitory computer-readable medium described herein, the one or more RSRP change thresholds may be associated with a reference candidate cell of the set of multiple candidate cells.

Some examples of the method, serving cells, and non-transitory computer-readable medium described herein may further include operations, features, means, or instructions for obtaining, from the UE, a second report indicating an invalidity of the common TA, where the second report includes a C-TAG identifier, an indication of a first subset of candidate cells of the set of multiple candidate cells that may be associated with valid individual TAs, an indication of a second subset of candidate cells of the set of multiple candidate cells that may be associated with invalid individual TAs, an indication of the valid individual TAs associated with the first subset of candidate cells, or any combination thereof.

In some examples of the method, serving cells, and non-transitory computer-readable medium described herein, the control signaling indicating the C-TAG includes an RRC message, a MAC-CE, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support candidate cell timing advance group (C-TAG) management in conditional lower-layer triggered mobility (LTM) in accordance with one or more aspects of the present disclosure.

FIG. 3 shows an example of a process flow that supports C-TAG management in conditional LTM in accordance with one or more aspects of the present disclosure.

FIGS. 4 and 5 show block diagrams of devices that support C-TAG management in conditional LTM in accordance with one or more aspects of the present disclosure.

FIG. 6 shows a block diagram of a communications manager that supports C-TAG management in conditional LTM in accordance with one or more aspects of the present disclosure.

FIG. 7 shows a diagram of a system including a device that supports C-TAG management in conditional LTM in accordance with one or more aspects of the present disclosure.

FIGS. 8 and 9 show block diagrams of devices that support C-TAG management in conditional LTM in accordance with one or more aspects of the present disclosure.

FIG. 10 shows a block diagram of a communications manager that supports C-TAG management in conditional LTM in accordance with one or more aspects of the present disclosure.

FIG. 11 shows a diagram of a system including a device that supports C-TAG management in conditional LTM in accordance with one or more aspects of the present disclosure.

FIGS. 12 through 15 show flowcharts illustrating methods that support C-TAG management in conditional LTM in accordance with one or more aspects of the present disclosure.

### DETAILED DESCRIPTION

A user equipment (UE) may perform handover from a source cell to a target cell according to a handover procedure. For example, the UE may perform handover according to a lower-layer triggered mobility (LTM) (e.g., Layer 1 (L1)/Layer 2 (L2) triggered mobility) procedure. According to the LTM procedure, UEs may move between cells associated with different network entities, such as by performing inter-network entity handovers, based on one or more conditions (e.g., conditional handover (CHO) conditions) being satisfied. For example, a UE may handover from a source cell to a target cell based on satisfaction of the one or more conditions. In some cases, an LTM procedure involving satisfaction of conditions may be referred to as a conditional LTM (C-LTM) procedure. Such a handover, in some cases, may be referred to as an “autonomous” handover. For example, because the UE performs the handover based on satisfaction of the one or more conditions, the handover may be considered autonomously performed by the UE. To enable performance of C-LTM procedures, UEs may acquire information associated with candidate cells prior to handover. For example, UEs may acquire timing advance (TA) information of candidate cells such that the UEs may switch autonomously to a target cell after the one or more conditions are satisfied. However, obtaining TA information for multiple candidate cells may involve signaling overhead (e.g., random access channel (RACH) overhead), throughput degradation associated with interruptions, or both.

Techniques described herein may reduce signaling overhead, facilitate more efficient handovers, and improve throughput by grouping candidate cells into a candidate cell TA group (C-TAG). For example, a UE may obtain a common TA for the C-TAG rather than individually obtaining TA information from multiple candidate cells. That is, rather than communicating with each candidate cell of multiple candidate cells to obtain TA information, the UE may obtain a common TA that is applicable to all the candidate cells of the C-TAG. In some examples, the UE may obtain the common TA via signaling from the serving cell. Alternatively, the UE may use a previously indicated TA or a measured TA of a candidate cell in the C-TAG as the common TA. The common TA may be applied to each of the candidate cells or, in some examples, candidate cells may be associated with individual TAs represented as deviations from the common TA. For example, the signaling from the serving cell indicating the common TA may, in some examples, include one or more indications of deviations from the common TA for candidate cells having different TAs than the common TA.

Aspects of the disclosure are initially described in the context of wireless communications systems. Aspects of the disclosure are also described in the context of a process flow. Aspects of the disclosure are further illustrated by and described with reference to apparatus diagrams, system diagrams, and flowcharts that relate to C-TAG management in conditional LTM.

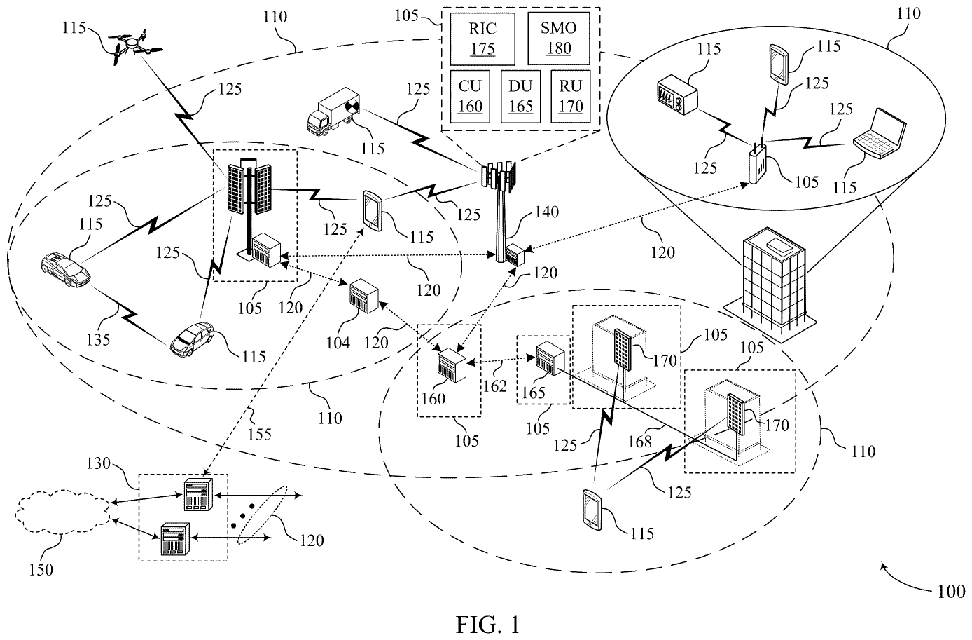

FIG. 1 shows an example of a wireless communications system 100 that supports C-TAG management in conditional LTM in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support C-TAG management in conditional LTM as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

A UE 115 may perform handover within the wireless communications system 100 according to an LTM procedure. The LTM procedure may, compared with other handover procedures (e.g., Layer 3 (L3) handover), support mobility between cells under different network entities (e.g., different gNBs or CUs), measurements via reference signals such as synchronization signal blocks (SSBs), and conditional mobility procedures (e.g., in addition to or alternatively from LTM cell switch command (CSC) MAC-control element (CE)-based execution). For example, the LTM procedure may support conditional LTM cell switching by the UE 115, including conditional intra-CU LTM, according to UE-evaluated triggering conditions, support subsequent LTM(s), support a scenario when the UE 115 is in a dual connectivity (DC) configuration or another configuration, or the like.

The UE 115 may perform C-LTM. C-LTM may be triggered by one or more measurements, including by L1 measurements at a MAC layer, L3 measurements at an RRC layer, or both (e.g., CHO conditions). Put another way, for L1-based C-LTM, the condition evaluation may be at the MAC level, and, for L3-based C-LTM, the condition evaluation may be at RRC level. The UE 115 may, in such cases, maintain one or more candidate cell TAs via one or more timers. That is, a candidate cell TA may be maintained by a timer at the UE 115, where the UE 115 may utilize the TA to communicate with the candidate cell in cases where the UE 115 performs a handover to the candidate cell.

In some examples, the satisfaction of one or more conditions (e.g., CHO conditions that may be defined by the network via relevant standards, such as CondEventA3 and/or CondEventA5 conditions) may be a baseline for C-LTM execution. In some cases, an L1 execution condition of a candidate cell may be associated with a single triggering event. Alternatively, an L3 execution condition may involve one or more triggering events or conditions. If there are two triggering conditions associated with a same candidate cell, the UE 115 may consider the execution condition as fulfilled when both triggering conditions are met. C-LTM may support a single reference signal type, and a maximum of two different triggering event or condition quantities may be configured simultaneously for the evaluation of an execution condition of a single candidate cell. To support initial and subsequent C-LTM, one or more of the following may be considered for the configuration of the execution condition: the C-LTM configuration of each candidate cell may include the execution condition for initial conditional LTM, which may be generated by the initial source cell to trigger the C-LTM for the candidate cell; and/or the C-LTM configuration of each candidate cell may include execution conditions for subsequent C-LTM, which may be generated by the candidate cell to trigger the C-LTM for other candidate cells when the candidate cell becomes a serving cell. The network entity 105 may configure measurement reports (e.g., L1 periodic, semi-persistent, aperiodic and event triggered report, or L3 measurement reports) for C-LTM, such as to trigger physical downlink control channel (PDCCH)-ordered early RACH. For C-LTM, a candidate cell transmission configuration indicator (TCI) state activation/deactivation MAC-CE may be re-used for the early activation/deactivation of TCI state(s) of a C-LTM candidate configuration. In some examples, an early TA may be signaled to the UE 115 from the source cell (i.e., not from the candidate cell directly to the UE 115). The network entity 105 may indicate candidate cell TA information to the UE via a new MAC-CE, which may include the TA value when the UE 115 switches to that candidate cell during C-LTM.

The UE 115 may maintain a valid TA for candidate cell(s) as part of some LTM procedures, including RACH-less or C-LTM procedures. For example, the UE 115 may use a TA to perform an initial transmission to a target cell (e.g., of the candidate cell(s)), and the target cell may successfully receive the initial transmission based on whether the TA is valid. Because the UE 115 may determine to switch to a candidate cell (e.g., rather than the serving cell), the UE 115 may perform early TA acquisition for all possible candidate cells. That is, the UE 115 may obtain the TAs of candidate cells (e.g., proximate to the UE 115, such as within a threshold distance or having a threshold signal strength) prior to selecting a target cell or an LTM procedure being triggered. Such an early TA acquisition may involve RACH overhead, throughput degradation associated with interruption, or both.

Accordingly, techniques described herein support a C-TAG in which one or more candidate cells are formed into a group sharing a common TA validation timer, reference signal received power (RSRP) change threshold, or both. The UE 115 may receive signaling, perform validation, and transmit PDCCH-ordered RACH requests in association with the C-TAG (e.g., rather than individual candidate cells).

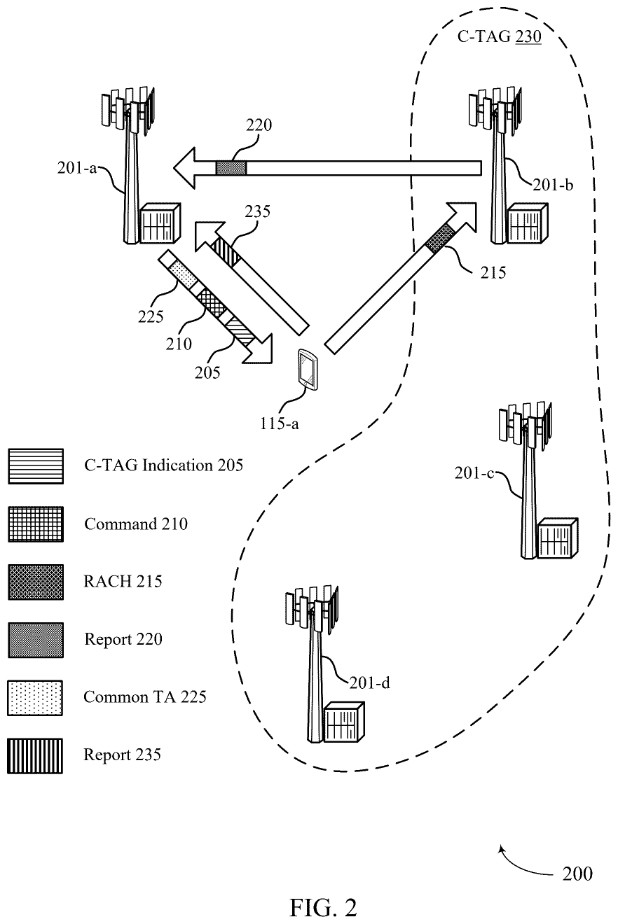

FIG. 2 shows an example of a wireless communications system 200 that supports C-TAG management in conditional LTM in accordance with one or more aspects of the present disclosure. The wireless communications system 200 may implement, or be implemented by, the wireless communications system 100. For example, the wireless communications system 200 may include a serving cell 201-a, a candidate cell 201-b, a candidate cell 201-c, a candidate cell 201-d, and a UE 115-a, which may be examples of corresponding devices as described with reference to FIG. 1.

For the purposes of the present disclosure, the terms “cell 201,” “serving cell 201,” “candidate cell 201,” and like terms, may refer to a set of hardware resources and/or time/frequency/spatial resources that supports communications between the network and UEs 115-a. That is, each serving cell 201 may be associated with, or supported by, one or more network entities 105. Similarly, a network entity 105 may be associated with, or support, one or more cells.

The UE 115-a may be configured with a TA group of one or more candidate cells, which may be referred to as a C-TAG 230. For example, the UE 115-a may receive, from the serving cell 201-a, a control message including a C-TAG indication 205. The C-TAG indication 205 may indicate that the candidate cell 201-b (e.g., a first candidate cell), the candidate cell 201-c (e.g., a second candidate cell), and the candidate cell 201-d (e.g., a third candidate cell) are included in a C-TAG 230. In some aspects, each serving cell 201 of the C-TAG 230 may include one or more TRPs. For example, in some cases, the candidate cell 201-d of the C-TAG 230 may include an mTRP-based cell with at least a first TRP (TRP0) and a second TRP (TRP1), where the first TRP and the second TRP are included within or otherwise associated with the C-TAG 230. While the C-TAG 230 includes three candidate cells 201 in the example of FIG. 2, it may be understood that the C-TAG 230 may include fewer or greater than three candidate cells 201, and that a network may include one or more C-TAGs 230. That is, the C-TAG 230 may include multiple or a plurality of candidate/neighboring cells 201. For example, in alternative cases, the C-TAG 230 may include the candidate cells 201-b and 201-c, where the candidate cell 201-d may be included within or otherwise associated with a separate C-TAG (not shown). Moreover, in cases where a single candidate cell 201 includes an mTRP-based cell, the respective TRPs of the candidate cell 201 may be included within the same or different C-TAGs. For instance, in cases where the candidate cell 201-d includes an mTRP-based cell with a first TRP (TRP0) and a second TRP (TRP1), where first TRP may be included within or otherwise associated with the C-TAG 230, and the second TRP may be included within or otherwise associated with a separate C-TAG.

The control message including the C-TAG indication 205 may include a C-TAG identifier, one or more candidate cell 201 identifiers (e.g., identifiers of the candidate cell 201-b, the candidate cell 201-c, and the candidate cell 201-d included in the C-TAG 230), one or more RSRP change thresholds (e.g., one or more L1 RSRP change thresholds, one or more L3 RSRP change thresholds, or both), and one or more validation timers.

For example, the control message may indicate a single RSRP change threshold (e.g., a single L1 RSRP change threshold, a single L3 RSRP change threshold, or both) applicable to each candidate cell in the C-TAG 230. Additionally, or alternatively, the control message may indicate multiple RSRP change thresholds applicable to individual candidate cells in the C-TAG 230. For example, the control message may indicate a first RSRP change threshold associated with the candidate cell 201-b, a second RSRP change threshold associated with the candidate cell 201-c, and a third RSRP change threshold associated with the candidate cell 201-d. In some examples, the control message may indicate multiple RSRP change thresholds, where an RSRP change threshold of the multiple RSRP change thresholds is applicable to multiple candidate cells. As an example, the control message may indicate a first RSRP change threshold associated with the candidate cell 201-b and the candidate cell 201-c, and a second RSRP change threshold associated with the candidate cell 201-d. That is, the control message may indicate RSRP change thresholds for individual candidate cells, RSRP change thresholds shared between two or more candidate cells, or both.

Similarly, the control message may indicate validation timers associated with individual candidate cells 201, validation timers shared between two or more candidate cells 201, or both. For example, the control message may indicate a validation timer applicable to each candidate cell 201 in the C-TAG 230. Additionally, or alternatively, the control message may indicate multiple validation timers applicable to individual candidate cells 201 in the C-TAG 230.

The UE 115-a may perform common TA management and validation for the C-TAG 230. By performing common TA management and validation, the UE 115-a may reduce a quantity of PDCCH-ordered RACH procedures (e.g., compared to performing PDCCH-ordered RACH procedures for individual candidate cells 201), reduce an amount of TA validation, or both. For example, the C-TAG indication 205 may indicate a common TA timer (e.g., a common validation timer), a common RSRP change threshold, or both for the C-TAG 230.

In some examples, the control message including the C-TAG indication 205 may be an RRC message (e.g., an RRC-based semi-static configuration or an RRC and MAC-CE-based dynamic configuration). In such examples, the serving cell 201-a may update the C-TAG 230 via RRC or via MAC-CE. Alternatively, the control message including the C-TAG indication 205 may be a MAC-CE message (e.g., a MAC-CE-based dynamic configuration). In such examples, the serving cell 201-a may update the C-TAG 230 via MAC-CE.

The UE 115-a may receive a command 210 indicating to perform a RACH procedure with a candidate cell 201 (e.g., command 210 to transmit a RACH 215 to a candidate cell 201 of the C-TAG 230). The command 210 may be a PDCCH-ordered RACH command. That is, the serving cell 201-a may transmit a downlink control message (e.g., a PDCCH message) including a command to initiate a RACH procedure with a candidate cell 201 of the C-TAG 230. Based on the command 210, the UE 115-a may transmit a RACH 215 message to the candidate cell 201-b (e.g., the candidate cell 201 indicated in the command 210). For example, the UE 115-a may perform a single PDCCH-ordered RACH with a single candidate cell 201 rather than multiple PDCCH-ordered RACHs to multiple candidate cells 201. Accordingly, the UE 115-a may reduce signaling overhead with the serving cell 201-a (e.g., reduce a quantity of PDCCH-ordered RACH commands) and the candidate cells 201, including the candidate cell 201-b, the candidate cell 201-c, and the candidate cell 201-d (e.g., reduce a quantity of RACHs).

The candidate cell 201-b may transmit a report 220 to the serving cell 201-a based on the RACH 215. For example, the candidate cell 201-b may transmit a report 220 including TA information to the serving cell 201-a, such as via a backhaul link. The serving cell 201-a may, based on the report 220, transmit an indication of a common TA 225 to the UE 115-a. That is, the serving cell 201-a may transmit TA signaling to the UE 115-a. The UE 115-a may apply the common TA 225 to candidate cells 201 in the C-TAG 230. For example, because the candidate cell 201-b associated with the common TA 225 is included in the C-TAG 230, the UE 115-a may apply the common TA 225 to the candidate cell 201-c and the candidate cell 201-d. Put another way, the UE 115-a may use the common TA 225 to communicate with the candidate cell 201-c, the candidate cell 201-d, or both, even without transmitting separate RACHs 215 to the candidate cell 201-c or the candidate cell 201-d. In cases where the C-TAG 230 includes mTRP-based cells, the common TA 225 may be applied to all (or a subset) of TRPs of the mTRP-based cell.

In some examples, the serving cell 201-a may indicate the common TA 225 via group-level signaling (e.g., via a MAC-CE). That is, based on a signaling type (e.g., group-level signaling) used to indicate the common TA 225, the UE 115-a may determine that the common TA 225 is applicable to the C-TAG 230. Put another way, the UE 115-a may assume to use the signaled common TA 225 for all candidate cells 201 within the C-TAG 230, including candidate cells 201 for which the UE 115-a has not performed a PDCCH-ordered RACH procedure.

For the purposes of the present disclosure, the term “common TA 225” may be used to refer to a TA value that is common across the C-TAG 230 as a whole (e.g., associated with all candidate cells 201 of the C-TAG 230), whereas the term “individual TA” may be used to refer to TA values that are specific to individual cells 201. Thus, in some cases, in order to communicate with the candidate cell 201-b, the UE 115-a may be configured to use the common TA 225 for the C-TAG 230, the individual TA for the candidate cell 201-b, or both. The individual TAs may be different from the common TA 225. For example, the common TA 225 may be an average, weighted average, etc., of the individual TAs of the candidate cells 201 in the C-TAG 230.

In some aspects, the group-level signaling may include one or more delta values for one or more candidate cells 201 for determining individual TAs for the respective cells based on the common TA 225. That is, the group-level signaling may indicate a deviation of one or more individual TAs of one or more candidate cells 201 from the common TA 225 (and/or from the individual TA of another candidate cell, etc.). In such examples, the UE 115-a may store different individual TA values for different candidate cells in the C-TAG 230. For instance, the serving cell 201-a may indicate a common TA 225 associated with all candidate cells 201 of the C-TAG 230, and may indicate separate delta/deviation values that are used to determine/derive individual TAs of the individual candidate cells 201 based on the common TA 225. For instance, the candidate cell 201-b may be associated with an individual TA that is +Xms relative to the common TA 225, where the candidate cell 201-c may be associated with an individual TA that is −Yms relative to the common TA 225 (where the values +Xms and −Yms are considered “delta values” or “deviation values” for the candidate cells 201).

Alternatively, the UE 115-a may determine a common TA 225 absent group-level signaling. For example, when group-level signaling is not provided or when cell-level signaling is provided, the UE 115-a may determine an individual TA for a candidate cell 201 whose individual TA is unknown or invalid (e.g., the UE 115-a performed PDCCH-ordered RACH a long time ago such that the individual TA is invalid, the UE 115-a has not performed PDCCH-ordered RACH for the candidate cell, etc.). That is, the UE 115-a may receive the indication of an individual TA via cell-level signaling, where the cell-level signaling does not indicate that the individual TA is applicable to the C-TAG 230 (e.g., is not a common TA 225). In such examples, the UE 115-a may determine the common TA 225 for the C-TAG 230 based on available or valid individual TAs for other candidate cells within the C-TAG 230. For example, the UE 115-a may obtain one or more individual TAs associated with one or more candidate cells in the C-TAG 230. The UE 115-a may determine, from the one or more individual TAs, a minimum, a maximum, an average, or a weighted average to use as a common TA 225 for candidate cells 201 within the C-TAG 230. In such examples, the UE 115-a may calculate the common TA 225 based on an RRC configuration or information stored in the memory of the UE 115.

Alternatively, the UE 115-a may measure an individual TA of at least one candidate cell 201 and use the measured individual TA as the common TA 225 for the C-TAG 230. For example, the UE 115-a may exchange reference signals with the candidate cell 201-c and measure an individual TA. The UE 115-a may use the measured individual TA as the common TA 225 based on the candidate cell 201-c being included within the C-TAG 230. The UE 115 may determine the common TA 225 based on available or valid individual TAs, or based on measurements according to a configuration from the serving cell 201-a. That is, the serving cell 201-a may indicate, via the control message including the C-TAG indication 205 or via a different control message, that the UE 115-a is to determine a common TA 225 based on valid individual TAs obtained by the UE 115-a (e.g., prior to receipt of the indication), or based on measuring an individual TA of a candidate cell in the C-TAG 230 (e.g., after receipt of the indication).

The UE 115-a may reset a validation timer based on receiving the indication of the common TA 225 (e.g., via group-level signaling or cell-level signaling). For example, when the UE 115-a receives the indication of the common TA 225, the UE 115-a may reset the validation timer associated with the C-TAG 230. In some cases, the UE 115-a may reset the validation timer for the common TA 225 in cases where an individual TA for an individual candidate cell 201 within the C-TAG 230 is updated (e.g., update the validation timer for the common TA 225 when an individual TA for any of candidate cells 201-b, 201-c, 201-d is updated via cell-level signaling).

The UE 115-a may use the RSRP change thresholds, the validation timers, or both, to validate the common TA 225 for the C-TAG 230 and/or individual TAs of the individual candidate cells 201. For example, the UE 115-a may determine whether an individual TA is valid for a candidate cell 201, and/or whether the common TA 225 is valid for the C-TAG 230, based on an RSRP change threshold, a validation timer, or both, associated with the candidate cell 201 or C-TAG 230. The individual TA and/or common TA 225 may be valid according to an RSRP change threshold if a current RSRP value of a downlink pathloss reference signal is within (e.g., has not increased or decreased by more than) the RSRP change threshold from a stored RSRP value and if the current RSRP value and the stored RSRP value are valid.

For instance, the UE 115-a may perform measurements (e.g., RSRP measurements) on reference signals received from the candidate cell 201-b to determine whether the RSRP of the candidate cell 201-b changes by more than some RSRP change threshold. If the RSRP of the candidate cell 201-b does not change significantly (e.g., change is less than the RSRP threshold, or otherwise does not satisfy the RSRP change threshold), then the UE 115-a may determine that the individual TA for the candidate cell 201-b and/or the common TA 225 for the C-TAG 230 remains valid. Conversely, if the RSRP of the candidate cell 201-b changes significantly (e.g., change is greater than the RSRP threshold, or otherwise satisfies the RSRP change threshold), then the UE 115-a may determine that the individual TA for the candidate cell 201-b and/or the common TA 225 for the C-TAG 230 is no longer valid.

Additionally, or alternatively, the UE 115-a may determine that individual TAs and/or the common TA 225 are valid according to a validation timers (e.g., TA is valid if the corresponding validation timer has not yet expired). That is, a validation timer may indicate how long a TA is valid for (e.g., whether a transmission would be time aligned if the TA is used some time from when the TA was indicated). In some cases, the UE 115-a may determine whether or not the common TA 225 is valid by evaluating a single validation timer associated with the common TA 225. Additionally, or alternatively, the UE 115-a may determine whether or not the common TA 225 is valid by evaluating separate validation timers associated with the individual TAs of the respective candidate cells 201-b, 201-c, 201-d (e.g., common TA 225 is valid as long as all, at least one, or some threshold quantity of validation timers for the individual TAs are valid).

The UE 115-a may determine whether the common TA 225 (or an individual TA) is valid based on the validation timer, the RSRP change threshold, or both. That is, in some examples, the UE 115-a may determine a validity or an invalidity of the common TA 225 according to the validation timer (e.g., without the RSRP change threshold). In some other examples, the UE 115-a may determine a validity or an invalidity of the common TA 225 according to the RSRP change threshold (e.g., without the validation timer). Or, the UE 115-a may determine the validity or the invalidity of the common TA 225 according to both the validation timer and the RSRP change threshold.

In some examples, the UE 115-a may declare an invalid common TA 225 for the C-TAG 230 (e.g., declare the common TA 225 invalid) based on a threshold quantity of cells 201 having expired validation timers, satisfying RSRP change thresholds, or both. For example, the UE 115-a may declare an invalid common TA 225 for the C-TAG 230 based on at least one candidate cell 201 (e.g., all candidate cells, or a threshold quantity/percentage of candidate cells 201) within the C-TAG 230 having invalid individual TAs.

The UE 115-a may transmit a report 235 to indicate the invalid common TA 225 for the C-TAG 230. For example, based on declaring the invalid common TA 225 for the C-TAG 230, the UE 115-a may transmit a report 235 (e.g., a MAC-CE report) to the serving cell 201-a to inform the serving cell 201-a of the invalid common TA 225 for the C-TAG 230. The report 235 may include the C-TAG identifier, a list of candidate cell identifiers for which invalid individual TAs are detected, a list of one or more SSBs for candidate cells with invalid individual TAs (e.g., to prepare a possible PDCCH-ordered RACH), a list of candidate cell identifiers for which valid individual TAs are present, a list of valid individual TA values, or any combination thereof. In other words, the report 235 may indicate invalid individual TAs that caused the common TA 225 to be invalid. The UE 115-a may transmit the report 235 in accordance with a timer (e.g., prohibit timer). For example, the UE 115-a may restart the timer after transmitting the report 235 and retransmit the report when the timer expires (e.g., to avoid frequent transmissions).

In some examples, the UE 115-a may autonomously transmit a request for the command 210 to initiate a RACH procedure (e.g., a PDCCH-ordered RACH request) for a candidate cell 201 in the C-TAG 230 according to a prohibit timer. For example, the UE 115-a may reset the prohibit timer after transmitting the request and, after the prohibit timer expires, retransmit the request. In some examples, the request may include an identifier of the C-TAG 230, one or more identifiers of candidate cells 201, one or more SSB indices, or a combination thereof. The UE 115-a may transmit the request via an uplink control information (UCI) message or via a MAC-CE message. In examples in which the UE 115-a transmits the request via the UCI message, the UE 115-a may use a dedicated scheduling request or UCI resource that is configured for the C-TAG 230. That is, the UE 115-a may use the dedicated scheduling request or UCI resource such that the serving cell 201-a may identify that the UE 115-a is requesting the command 210 for the C-TAG 230.

In some examples, in addition to transmitting the request according to a prohibit timer, the UE 115-a may transmit the request according to a priority rule. For example, the UE 115-a may transmit the request and, while waiting for a response, an SSB included in the request may have decreased performance compared to another SSB that may be used for the RACH. For example, after transmitting the request indicating a first SSB associated with the candidate cell 201-b, a second SSB may become better than the first SSB. Accordingly, the UE 115-a may transmit another request that indicates the second SSB (e.g., regardless of whether the prohibit timer has expired).

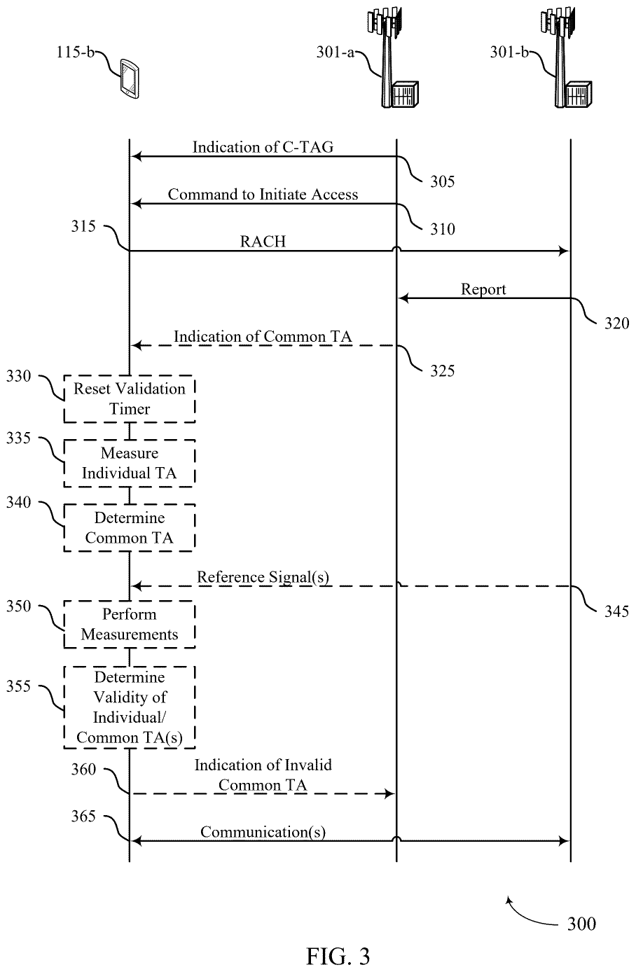

FIG. 3 shows an example of a process flow 300 that supports C-TAG management in conditional LTM in accordance with one or more aspects of the present disclosure. The process flow 300 may implement or be implemented by aspects of the wireless communications system 100, the wireless communications system 200, or both. For example, the process flow 300 may include a serving cell 301-a, a candidate cell 301-b, and a UE 115-b, which may be examples of corresponding devices as described with reference to FIGS. 1 and 2. As noted previously herein, the serving cell 301-a and the candidate cell 301-b may each be associated with (e.g., supported by) one or more network entities 105.

Alternative examples of the following may be implemented, where some operations are performed in a different order than described or are not performed at all. In some examples, operations may include additional features not mentioned below, or further operations may be added. Although the serving cell 301-a, the candidate cell 301-b, and the UE 115-b are shown performing the operations of the process flow 300, some aspects of some operations may also be performed by one or more other wireless devices.

At operation 305, the UE 115-b may receive an indication of a C-TAG. For example, the UE 115-b may receive, from the serving cell 301-a (e.g., from a network entity 105 associated with the serving cell 301-a), control signaling indicating a C-TAG including multiple candidate cells 301. The C-TAG may be an example of the C-TAG 230 and the indication may be an example of the C-TAG indication 205 as described with reference to FIG. 2. The control signaling may include an RRC message, a MAC-CE message, or both. In some examples, the control signaling indicating the C-TAG may indicate a C-TAG identifier, candidate cell identifiers of the multiple candidate cells 301, one or more RSRP change thresholds for evaluating a validity of a common TA for the C-TAG, one or more validation timers associated with the common TA, or any combination thereof.

In examples in which the control signaling indicates the one or more validation timers, the one or more validation timers may include a single validation timer associated with the multiple candidate cells 301 or multiple validation timers, where each validation timer of the multiple validation timers is associated with one or more respective candidate cells 301 of the multiple candidate cells 301 of the C-TAG.

At operation 310, the UE 115-b may receive a command to initiate access. For example, the UE 115-b may receive, from the serving cell 301-a, a downlink control message including a command to initiate access with the candidate cell 301-b of the C-TAG. The command may be an example of the command 210 as described with reference to FIG. 2.

At operation 315, the UE 115-b may transmit a RACH to the candidate cell 301-b For example, the UE 115-b may transmit, to the candidate cell 301-b (e.g., to a network entity 105 associated with the candidate cell 301-b), a RACH message based on the command to initiate access with the candidate cell 301-b. That is, the RACH message may be an example of a PDCCH-ordered RACH. The RACH message may be an example of the RACH 215 as described with reference to FIG. 2. In some examples, the UE 115-b may transmit the RACH based on expiration of a prohibit timer. Additionally, or alternatively, the RACH message may include a C-TAG identifier of the C-TAG, a candidate cell identifier of the candidate cell 301-b, an SSB index, or any combination thereof.

At operation 320, the candidate cell 301-b may transmit a report to the serving cell 301-a. For example, the serving cell 301-a may obtain, from the candidate cell 301-b of the C-TAG, a report including an indication of a common TA for the C-TAG. Additionally, or alternatively, the report may indicate an individual TA for the candidate cell 301-b (where the individual TA may be used by the serving cell 301-a and/or the UE 115-b to determine/derive the common TA for the C-TAG). The report may be an example of the report 220 as described with reference to FIG. 2.

At operation 325, the serving cell 301-a may transmit an indication of a common TA to the UE 115-b. For example, the UE 115-b may obtain a common TA associated with the C-TAG based on transmitting the RACH message at operation 315. In some examples, the UE 115-b may obtain the common TA by receiving, from the serving cell 301-a, second control signaling indicating the common TA associated with the C-TAG based on the candidate cell 301-b being associated with the C-TAG. The indication of the common TA may be an example of the TA 225 indicated by the serving cell 201-a as described with reference to FIG. 2.

At operation 330, the UE 115-b may reset a validation timer. For example, the UE 115-b may reset a validation timer associated with the common TA based on receiving the second control signaling at operation 325.

At operation 335, the UE 115-b may measure an individual TA associated with the candidate cell 301-b. That is, the UE 115-b may perform communications with the candidate cell 301-b, and may determine the individual TA for the candidate cell 301-b based on measurements performed on the communications. For example, the UE 115-b may obtain the common TA for the C-TAG by measuring an individual TA associated with the candidate cell 301-b, where the common TA is based on the individual TA associated with the candidate cell 301-b. At operation 340, the UE 115-b may determine a common TA for the C-TAG. For example, the UE 115-b may obtain the common TA by calculating/determining the common TA based on one or more individual TAs associated with one or more candidate cells 301 of the C-TAG.

At operation 345, the UE 115-b may receive reference signal(s) from the candidate cell 301-b. For example, the UE 115-b may receive reference signal(s) via one or more candidate cells 301 of the C-TAG. At operation 350, the UE 115-b may perform measurements. For example, the UE 115-b may perform measurements for the reference signal(s) received via the one or more candidate cells 301.

At operation 355, the UE 115-b may determine a validity of the individual TA associated with the candidate cell 301-b and/or a validity of the common TA associated with the C-TAG. For example, the UE 115-b may determine a validity of the individual TA and/or the common TA based on an individual or common validation timer, an RSRP change threshold, or both. As an example, the UE 115-b may determine a validity of the common TA based on a comparison between the measurements (e.g., from operation 350) and one or more RSRP change thresholds associated with the C-TAG. In some examples, the one or more RSRP change thresholds may include a single RSRP change threshold associated with the multiple candidate cells 301. In some other examples, the one or more RSRP change thresholds may include multiple RSRP change thresholds, each RSRP change threshold of the multiple RSRP change thresholds associated with one or more respective candidate cells 301 of the multiple candidate cells 301. Additionally, the one or more RSRP change thresholds may be associated with a reference candidate cell 301 of the multiple candidate cells.

In some examples, the validity of the common TA may be based on the validities of one or more individual TAs associated with one or more candidate cells 301 of the C-TAG, such as based on expiration of a validation timer associated with the common TA, measurements of reference signals received from one or more candidate cells 301 exceeding a measurement change threshold, or both.

At operation 360, the UE 115-b may transmit an indication of an invalid common TA. For example, the UE 115-b may determine an invalidity of the common TA (e.g., based on determining the validity of TA(s) at operation 355) and transmit, to the serving cell 301-a, a report indicating the invalidity of the common TA. The report may include a C-TAG identifier, an indication of a first subset of candidate cells 301 that are associated with valid individual TAs, an indication of a second subset of candidate cells 301 that are associated with invalid individual TAs, an indication of the valid individual TAs associated with the first subset of candidate cells 301, or any combination thereof. In such examples, the UE 115-b may transmit the report based on a timer (e.g., prohibit timer). The report may be an example of the report 235 as described with reference to FIG. 2.

At operation 365, the UE 115-b may perform communication(s) with the candidate cell 301-b. For example, the UE 115-b may communicate with at least one candidate cell 301 of the C-TAG based on the common TA. In some examples, communicating with the at least one candidate cell 301 may be based on the validity of the common TA. The UE 115 may communicate with a same candidate cell indicated in the command to initiate access (e.g., at operation 310), and/or with a different candidate cell from the C-TAG.

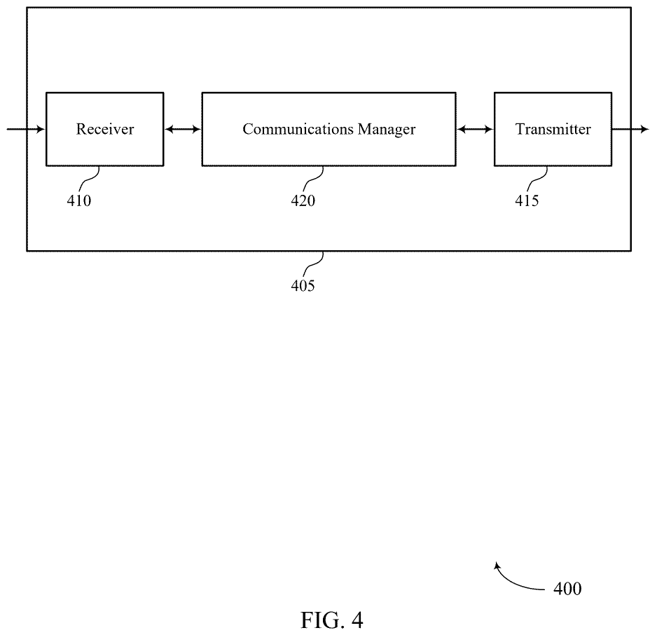

FIG. 4 shows a block diagram 400 of a device 405 that supports C-TAG management in conditional LTM in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to C-TAG management in conditional LTM). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to C-TAG management in conditional LTM). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of C-TAG management in conditional LTM as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a serving cell, control signaling indicating a C-TAG including a set of multiple candidate cells. The communications manager 420 is capable of, configured to, or operable to support a means for receiving, from the serving cell, a downlink control message including a command to initiate access with a candidate cell of the set of multiple candidate cells of the C-TAG. The communications manager 420 is capable of, configured to, or operable to support a means for transmitting, to the candidate cell, a RACH message based on the command to initiate access with the candidate cell. The communications manager 420 is capable of, configured to, or operable to support a means for obtaining a common TA associated with the C-TAG based on transmitting the RACH message. The communications manager 420 is capable of, configured to, or operable to support a means for communicating with at least one candidate cell of the set of multiple candidate cells of the C-TAG based on the common TA.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

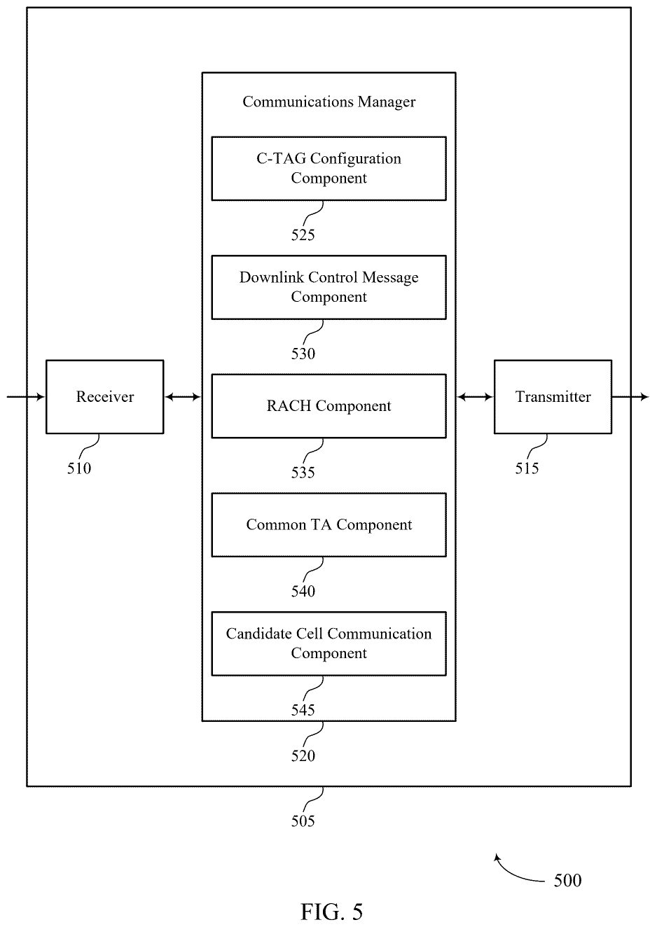

FIG. 5 shows a block diagram 500 of a device 505 that supports C-TAG management in conditional LTM in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to C-TAG management in conditional LTM). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to C-TAG management in conditional LTM). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of C-TAG management in conditional LTM as described herein. For example, the communications manager 520 may include a C-TAG configuration component 525, a downlink control message component 530, a RACH component 535, a common TA component 540, a candidate cell communication component 545, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The C-TAG configuration component 525 is capable of, configured to, or operable to support a means for receiving, from a serving cell, control signaling indicating a C-TAG including a set of multiple candidate cells. The downlink control message component 530 is capable of, configured to, or operable to support a means for receiving, from the serving cell, a downlink control message including a command to initiate access with a candidate cell of the set of multiple candidate cells of the C-TAG. The RACH component 535 is capable of, configured to, or operable to support a means for transmitting, to the candidate cell, a RACH message based on the command to initiate access with the candidate cell. The common TA component 540 is capable of, configured to, or operable to support a means for obtaining a common TA associated with the C-TAG based on transmitting the RACH message. The candidate cell communication component 545 is capable of, configured to, or operable to support a means for communicating with at least one candidate cell of the set of multiple candidate cells of the C-TAG based on the common TA.

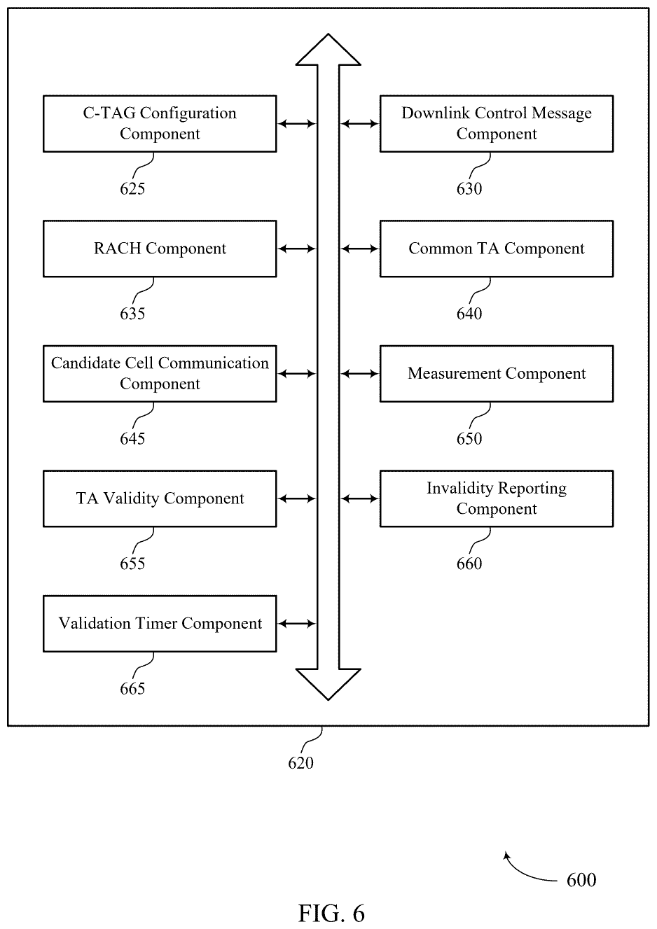

FIG. 6 shows a block diagram 600 of a communications manager 620 that supports C-TAG management in conditional LTM in accordance with one or more aspects of the present disclosure. The communications manager 620 may be an example of aspects of a communications manager 420, a communications manager 520, or both, as described herein. The communications manager 620, or various components thereof, may be an example of means for performing various aspects of C-TAG management in conditional LTM as described herein. For example, the communications manager 620 may include a C-TAG configuration component 625, a downlink control message component 630, a RACH component 635, a common TA component 640, a candidate cell communication component 645, a measurement component 650, a TA validity component 655, an invalidity reporting component 660, a validation timer component 665, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The C-TAG configuration component 625 is capable of, configured to, or operable to support a means for receiving, from a serving cell, control signaling indicating a C-TAG including a set of multiple candidate cells. The downlink control message component 630 is capable of, configured to, or operable to support a means for receiving, from the serving cell, a downlink control message including a command to initiate access with a candidate cell of the set of multiple candidate cells of the C-TAG. The RACH component 635 is capable of, configured to, or operable to support a means for transmitting, to the candidate cell, a RACH message based on the command to initiate access with the candidate cell. The common TA component 640 is capable of, configured to, or operable to support a means for obtaining a common TA associated with the C-TAG based on transmitting the RACH message. The candidate cell communication component 645 is capable of, configured to, or operable to support a means for communicating with at least one candidate cell of the set of multiple candidate cells of the C-TAG based on the common TA.

In some examples, to support obtaining the common TA, the common TA component 640 is capable of, configured to, or operable to support a means for receiving, from the serving cell, second control signaling indicating the common TA associated with the C-TAG based on the candidate cell being associated with the C-TAG.

In some examples, the validation timer component 665 is capable of, configured to, or operable to support a means for resetting a validation timer associated with the common TA based on receiving the second control signaling.

In some examples, to support obtaining the common TA, the common TA component 640 is capable of, configured to, or operable to support a means for determining the common TA based on one or more TAs associated with one or more candidate cells of the C-TAG.

In some examples, to support obtaining the common TA, the measurement component 650 is capable of, configured to, or operable to support a means for measuring an individual TA associated with the candidate cell, where the common TA is based on the individual TA associated with the candidate cell.

In some examples, the control signaling indicating the C-TAG further indicates a C-TAG identifier, candidate cell identifiers of the set of multiple candidate cells, one or more RSRP change thresholds for evaluating a validity of the common TA, one or more validation timers associated with the common TA, or any combination thereof.

In some examples, a single validation timer associated with the set of multiple candidate cells, or a set of multiple validation timers, each validation timer of the set of multiple validation timers associated with one or more respective candidate cells of the set of multiple candidate cells.

In some examples, the measurement component 650 is capable of, configured to, or operable to support a means for performing measurements for reference signals received via one or more candidate cells of the set of multiple candidate cells. In some examples, the TA validity component 655 is capable of, configured to, or operable to support a means for determining a validity of the common TA based on a comparison between the measurements and one or more RSRP change thresholds associated with the C-TAG, where communicating with the at least one candidate cell is based on the validity of the common TA.

In some examples, a single RSRP change threshold associated with the set of multiple candidate cells, or a set of multiple RSRP thresholds, each RSRP threshold of the set of multiple RSRP thresholds associated with one or more respective candidate cells of the set of multiple candidate cells.

In some examples, the one or more RSRP change thresholds are associated with a reference candidate cell of the set of multiple candidate cells.

In some examples, the TA validity component 655 is capable of, configured to, or operable to support a means for determining one or more validities of one or more individual TAs associated with one or more candidate cells of the C-TAG based on expiration of a validation timer associated with the common TA, measurements of reference signals received from one or more candidate cells exceeding a measurement change threshold, or both. In some examples, the TA validity component 655 is capable of, configured to, or operable to support a means for determining a validity of the common TA based on the one or more validities of the one or more individual TAs satisfying a threshold.

In some examples, the TA validity component 655 is capable of, configured to, or operable to support a means for determining an invalidity of the common TA. In some examples, the invalidity reporting component 660 is capable of, configured to, or operable to support a means for transmitting, to the serving cell, a report indicating the invalidity of the common TA, where the report includes a C-TAG identifier, an indication of a first subset of candidate cells of the set of multiple candidate cells that are associated with valid individual TAs, an indication of a second subset of candidate cells of the set of multiple candidate cells that are associated with invalid individual TAs, an indication of the valid individual TAs associated with the first subset of candidate cells, or any combination thereof.

In some examples, the report is transmitted based on a timer at the UE.

In some examples, the RACH message is transmitted based on an expiration of a prohibit timer.

In some examples, the RACH message includes a C-TAG identifier of the C-TAG, a candidate cell identifier of the candidate cell, a synchronization signal block index, or any combination thereof.

In some examples, the control signaling indicating the C-TAG includes an RRC message, a MAC-CE, or both.

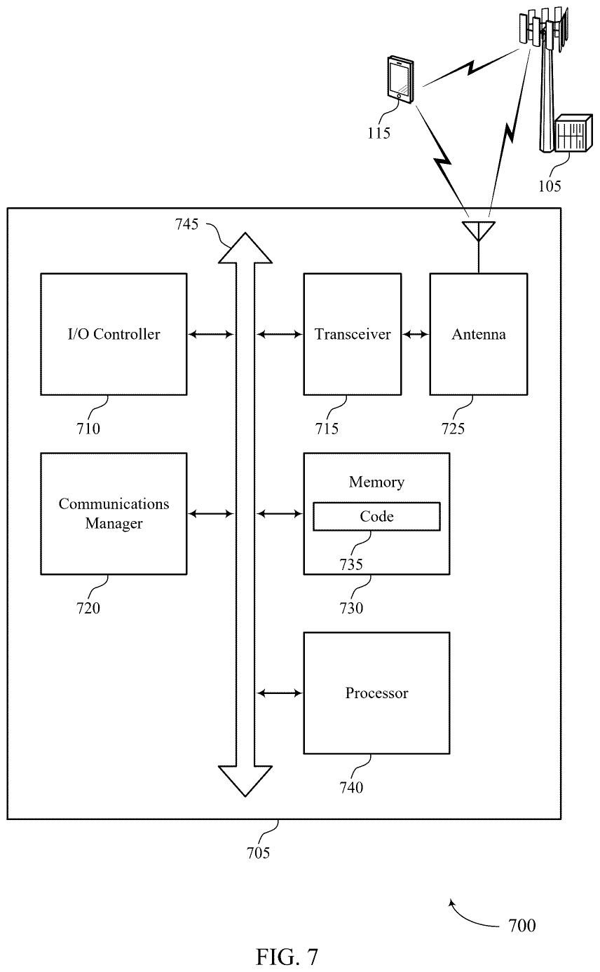

FIG. 7 shows a diagram of a system 700 including a device 705 that supports C-TAG management in conditional LTM in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting C-TAG management in conditional LTM). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, from a serving cell, control signaling indicating a C-TAG including a set of multiple candidate cells. The communications manager 720 is capable of, configured to, or operable to support a means for receiving, from the serving cell, a downlink control message including a command to initiate access with a candidate cell of the set of multiple candidate cells of the C-TAG. The communications manager 720 is capable of, configured to, or operable to support a means for transmitting, to the candidate cell, a RACH message based on the command to initiate access with the candidate cell. The communications manager 720 is capable of, configured to, or operable to support a means for obtaining a common TA associated with the C-TAG based on transmitting the RACH message. The communications manager 720 is capable of, configured to, or operable to support a means for communicating with at least one candidate cell of the set of multiple candidate cells of the C-TAG based on the common TA.

By including or configuring the communications manager 720 in accordance with examples as described herein, the device 705 may support techniques for more efficient utilization of communication resources and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of C-TAG management in conditional LTM as described herein, or the at least one processor 740 and the at least one memory 730 may be otherwise configured to, individually or collectively, perform or support such operations.

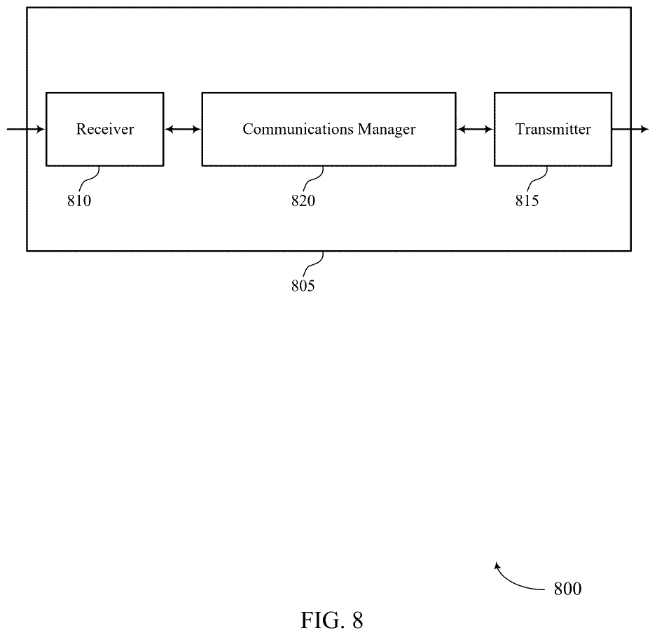

FIG. 8 shows a block diagram 800 of a device 805 that supports C-TAG management in conditional LTM in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of C-TAG management in conditional LTM as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting, to a UE, control signaling indicating a C-TAG including a set of multiple candidate cells. The communications manager 820 is capable of, configured to, or operable to support a means for outputting, to the UE, a downlink control message including a command to initiate access with a candidate cell of the set of multiple candidate cells of the C-TAG. The communications manager 820 is capable of, configured to, or operable to support a means for obtaining, from the candidate cell of the C-TAG, a report including an indication of a common TA. The communications manager 820 is capable of, configured to, or operable to support a means for outputting, to the UE, the common TA associated with the C-TAG based on obtaining the report.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

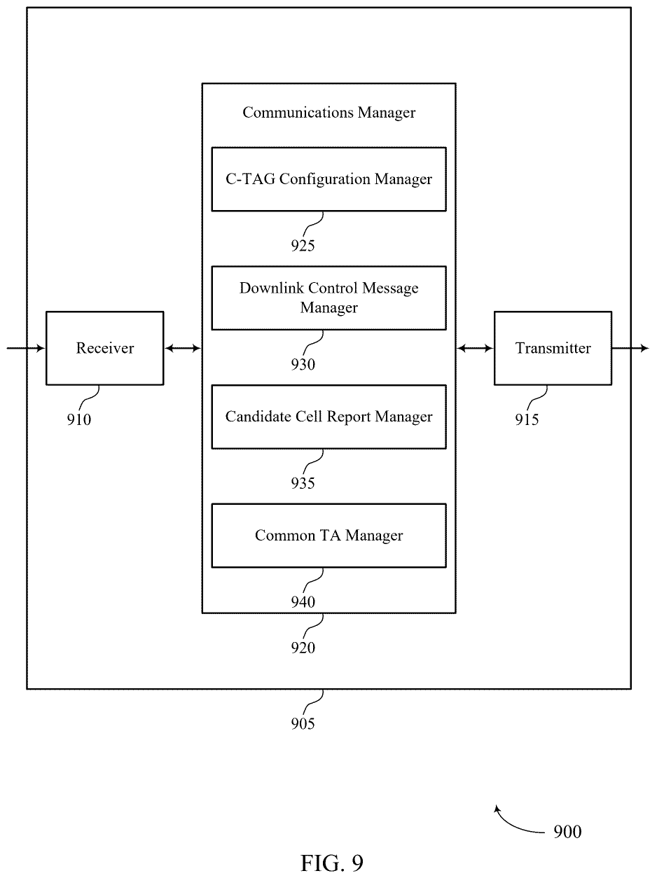

FIG. 9 shows a block diagram 900 of a device 905 that supports C-TAG management in conditional LTM in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of C-TAG management in conditional LTM as described herein. For example, the communications manager 920 may include a C-TAG configuration manager 925, a downlink control message manager 930, a candidate cell report manager 935, a common TA manager 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The C-TAG configuration manager 925 is capable of, configured to, or operable to support a means for outputting, to a UE, control signaling indicating a C-TAG including a set of multiple candidate cells. The downlink control message manager 930 is capable of, configured to, or operable to support a means for outputting, to the UE, a downlink control message including a command to initiate access with a candidate cell of the set of multiple candidate cells of the C-TAG. The candidate cell report manager 935 is capable of, configured to, or operable to support a means for obtaining, from the candidate cell of the C-TAG, a report including an indication of a common TA. The common TA manager 940 is capable of, configured to, or operable to support a means for outputting, to the UE, the common TA associated with the C-TAG based on obtaining the report.

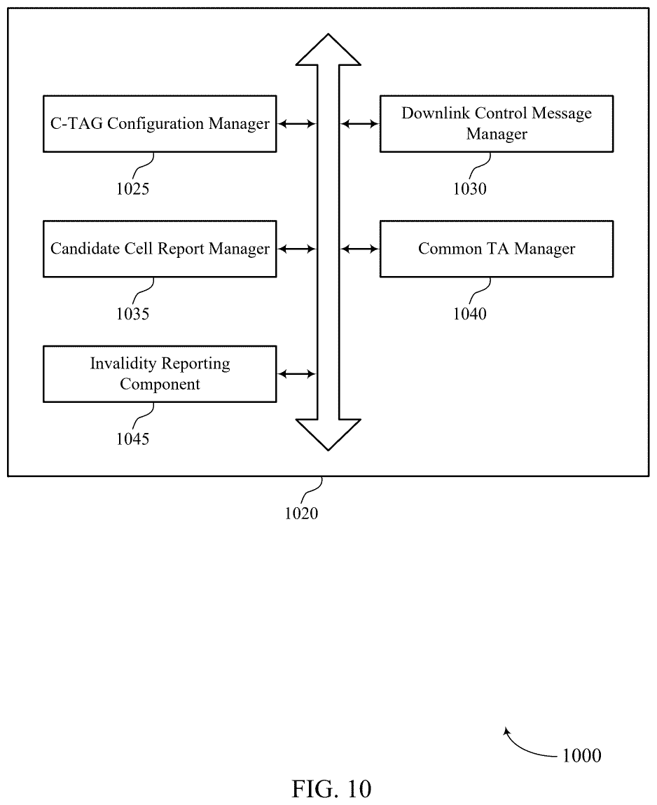

FIG. 10 shows a block diagram 1000 of a communications manager 1020 that supports C-TAG management in conditional LTM in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of C-TAG management in conditional LTM as described herein. For example, the communications manager 1020 may include a C-TAG configuration manager 1025, a downlink control message manager 1030, a candidate cell report manager 1035, a common TA manager 1040, an invalidity reporting component 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The C-TAG configuration manager 1025 is capable of, configured to, or operable to support a means for outputting, to a UE, control signaling indicating a C-TAG including a set of multiple candidate cells. The downlink control message manager 1030 is capable of, configured to, or operable to support a means for outputting, to the UE, a downlink control message including a command to initiate access with a candidate cell of the set of multiple candidate cells of the C-TAG. The candidate cell report manager 1035 is capable of, configured to, or operable to support a means for obtaining, from the candidate cell of the C-TAG, a report including an indication of a common TA. The common TA manager 1040 is capable of, configured to, or operable to support a means for outputting, to the UE, the common TA associated with the C-TAG based on obtaining the report.

In some examples, the control signaling indicating the C-TAG further indicates a C-TAG identifier, candidate cell identifiers of the set of multiple candidate cells, one or more RSRP change thresholds for evaluating a validity of the common TA, one or more validation timers associated with the common TA, or any combination thereof.

In some examples, a single validation timer associated with the set of multiple candidate cells, or a set of multiple validation timers, each validation timer of the set of multiple validation timers associated with one or more respective candidate cells of the set of multiple candidate cells.

In some examples, a single RSRP change threshold associated with the set of multiple candidate cells, or a set of multiple RSRP thresholds, each RSRP threshold of the set of multiple RSRP thresholds associated with one or more respective candidate cells of the set of multiple candidate cells.

In some examples, the one or more RSRP change thresholds are associated with a reference candidate cell of the set of multiple candidate cells.

In some examples, the invalidity reporting component 1045 is capable of, configured to, or operable to support a means for obtaining, from the UE, a second report indicating an invalidity of the common TA, where the second report includes a C-TAG identifier, an indication of a first subset of candidate cells of the set of multiple candidate cells that are associated with valid individual TAs, an indication of a second subset of candidate cells of the set of multiple candidate cells that are associated with invalid individual TAs, an indication of the valid individual TAs associated with the first subset of candidate cells, or any combination thereof.

In some examples, the control signaling indicating the C-TAG includes an RRC message, a MAC-CE, or both.

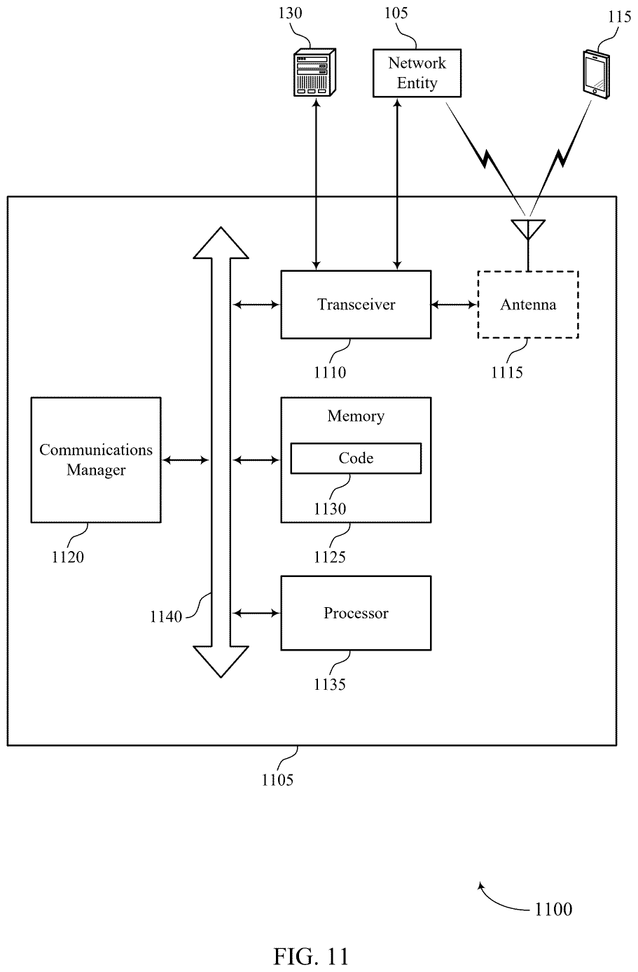

FIG. 11 shows a diagram of a system 1100 including a device 1105 that supports C-TAG management in conditional LTM in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting C-TAG management in conditional LTM). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting, to a UE, control signaling indicating a C-TAG including a set of multiple candidate cells. The communications manager 1120 is capable of, configured to, or operable to support a means for outputting, to the UE, a downlink control message including a command to initiate access with a candidate cell of the set of multiple candidate cells of the C-TAG. The communications manager 1120 is capable of, configured to, or operable to support a means for obtaining, from the candidate cell of the C-TAG, a report including an indication of a common TA. The communications manager 1120 is capable of, configured to, or operable to support a means for outputting, to the UE, the common TA associated with the C-TAG based on obtaining the report.

By including or configuring the communications manager 1120 in accordance with examples as described herein, the device 1105 may support techniques for more efficient utilization of communication resources and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of C-TAG management in conditional LTM as described herein, or the at least one processor 1135 and the at least one memory 1125 may be otherwise configured to, individually or collectively, perform or support such operations.

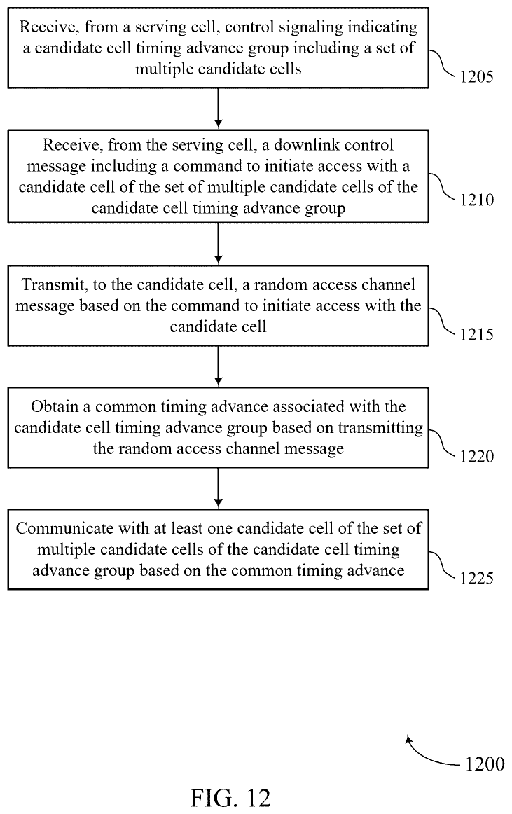

FIG. 12 shows a flowchart illustrating a method 1200 that supports C-TAG management in conditional LTM in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a serving cell, control signaling indicating a C-TAG including a set of multiple candidate cells. The operations of 1205 may be performed in accordance with examples as disclosed herein. In some examples, aspects of the operations of 1205 may be performed by a C-TAG configuration component 625 as described with reference to FIG. 6.

At 1210, the method may include receiving, from the serving cell, a downlink control message including a command to initiate access with a candidate cell of the set of multiple candidate cells of the C-TAG. The operations of 1210 may be performed in accordance with examples as disclosed herein. In some examples, aspects of the operations of 1210 may be performed by a downlink control message component 630 as described with reference to FIG. 6.

At 1215, the method may include transmitting, to the candidate cell, a RACH message based on the command to initiate access with the candidate cell. The operations of 1215 may be performed in accordance with examples as disclosed herein. In some examples, aspects of the operations of 1215 may be performed by a RACH component 635 as described with reference to FIG. 6.

At 1220, the method may include obtaining a common TA associated with the C-TAG based on transmitting the RACH message. The operations of 1220 may be performed in accordance with examples as disclosed herein. In some examples, aspects of the operations of 1220 may be performed by a common TA component 640 as described with reference to FIG. 6.

At 1225, the method may include communicating with at least one candidate cell of the set of multiple candidate cells of the C-TAG based on the common TA. The operations of 1225 may be performed in accordance with examples as disclosed herein. In some examples, aspects of the operations of 1225 may be performed by a candidate cell communication component 645 as described with reference to FIG. 6.

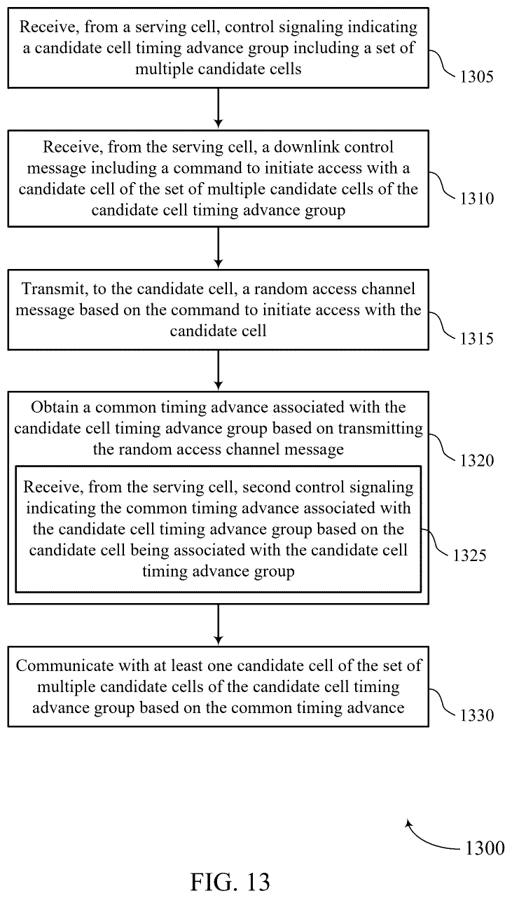

FIG. 13 shows a flowchart illustrating a method 1300 that supports C-TAG management in conditional LTM in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, from a serving cell, control signaling indicating a C-TAG including a set of multiple candidate cells. The operations of 1305 may be performed in accordance with examples as disclosed herein. In some examples, aspects of the operations of 1305 may be performed by a C-TAG configuration component 625 as described with reference to FIG. 6.

At 1310, the method may include receiving, from the serving cell, a downlink control message including a command to initiate access with a candidate cell of the set of multiple candidate cells of the C-TAG. The operations of 1310 may be performed in accordance with examples as disclosed herein. In some examples, aspects of the operations of 1310 may be performed by a downlink control message component 630 as described with reference to FIG. 6.

At 1315, the method may include transmitting, to the candidate cell, a RACH message based on the command to initiate access with the candidate cell. The operations of 1315 may be performed in accordance with examples as disclosed herein. In some examples, aspects of the operations of 1315 may be performed by a RACH component 635 as described with reference to FIG. 6.

At 1320, the method may include obtaining a common TA associated with the C-TAG based on transmitting the RACH message. The operations of 1320 may be performed in accordance with examples as disclosed herein. In some examples, aspects of the operations of 1320 may be performed by a common TA component 640 as described with reference to FIG. 6.

At 1325, obtaining the common TA may include receiving, from the serving cell, second control signaling indicating the common TA associated with the C-TAG based on the candidate cell being associated with the C-TAG. The operations of 1325 may be performed in accordance with examples as disclosed herein. In some examples, aspects of the operations of 1325 may be performed by a common TA component 640 as described with reference to FIG. 6.

At 1330, the method may include communicating with at least one candidate cell of the set of multiple candidate cells of the C-TAG based on the common TA. The operations of 1330 may be performed in accordance with examples as disclosed herein. In some examples, aspects of the operations of 1330 may be performed by a candidate cell communication component 645 as described with reference to FIG. 6.

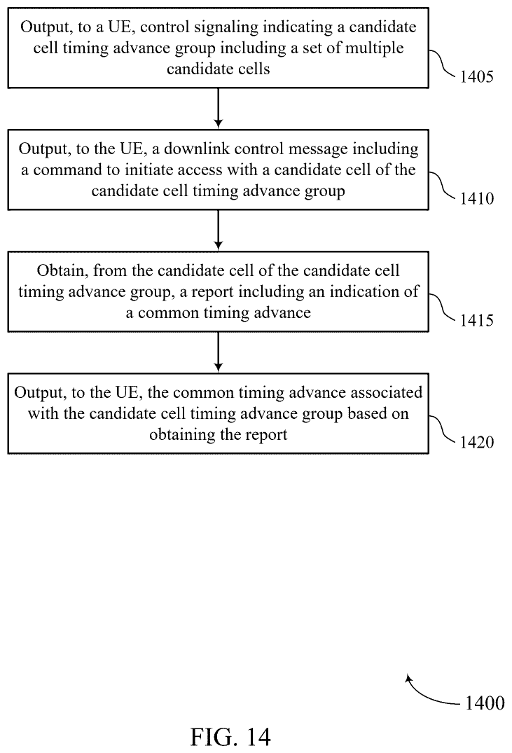

FIG. 14 shows a flowchart illustrating a method 1400 that supports C-TAG management in conditional LTM in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting, to a UE, control signaling indicating a C-TAG including a set of multiple candidate cells. The operations of 1405 may be performed in accordance with examples as disclosed herein. In some examples, aspects of the operations of 1405 may be performed by a C-TAG configuration manager 1025 as described with reference to FIG. 10.

At 1410, the method may include outputting, to the UE, a downlink control message including a command to initiate access with a candidate cell of the set of multiple candidate cells of the C-TAG. The operations of 1410 may be performed in accordance with examples as disclosed herein. In some examples, aspects of the operations of 1410 may be performed by a downlink control message manager 1030 as described with reference to FIG. 10.

At 1415, the method may include obtaining, from the candidate cell of the C-TAG, a report including an indication of a common TA. The operations of 1415 may be performed in accordance with examples as disclosed herein. In some examples, aspects of the operations of 1415 may be performed by a candidate cell report manager 1035 as described with reference to FIG. 10.

At 1420, the method may include outputting, to the UE, the common TA associated with the C-TAG based on obtaining the report. The operations of 1420 may be performed in accordance with examples as disclosed herein. In some examples, aspects of the operations of 1420 may be performed by a common TA manager 1040 as described with reference to FIG. 10.

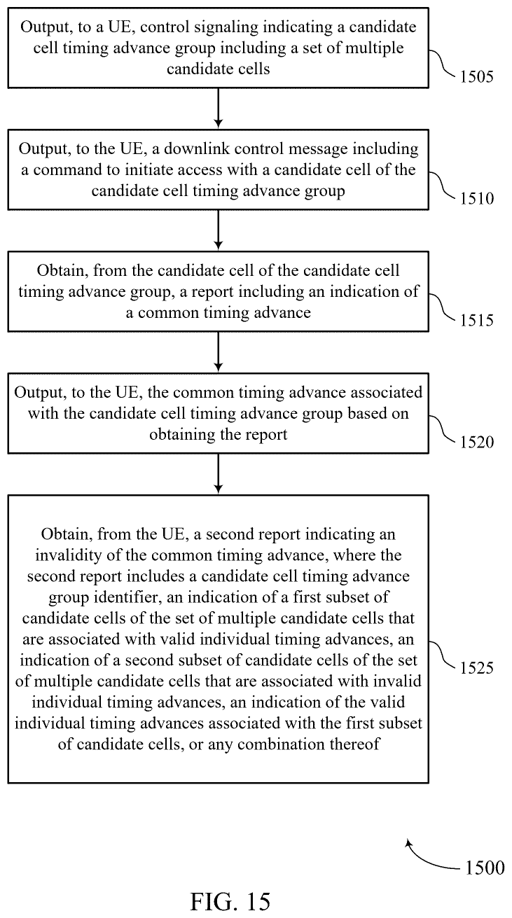

FIG. 15 shows a flowchart illustrating a method 1500 that supports C-TAG management in conditional LTM in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, control signaling indicating a C-TAG including a set of multiple candidate cells. The operations of 1505 may be performed in accordance with examples as disclosed herein. In some examples, aspects of the operations of 1505 may be performed by a C-TAG configuration manager 1025 as described with reference to FIG. 10.

At 1510, the method may include outputting, to the UE, a downlink control message including a command to initiate access with a candidate cell of the set of multiple candidate cells of the C-TAG. The operations of 1510 may be performed in accordance with examples as disclosed herein. In some examples, aspects of the operations of 1510 may be performed by a downlink control message manager 1030 as described with reference to FIG. 10.

At 1515, the method may include obtaining, from the candidate cell of the C-TAG, a report including an indication of a common TA. The operations of 1515 may be performed in accordance with examples as disclosed herein. In some examples, aspects of the operations of 1515 may be performed by a candidate cell report manager 1035 as described with reference to FIG. 10.

At 1520, the method may include outputting, to the UE, the common TA associated with the C-TAG based on obtaining the report. The operations of 1520 may be performed in accordance with examples as disclosed herein. In some examples, aspects of the operations of 1520 may be performed by a common TA manager 1040 as described with reference to FIG. 10.

At 1525, the method may include obtaining, from the UE, a second report indicating an invalidity of the common TA, where the second report includes a C-TAG identifier, an indication of a first subset of candidate cells of the set of multiple candidate cells that are associated with valid individual TAs, an indication of a second subset of candidate cells of the set of multiple candidate cells that are associated with invalid individual TAs, an indication of the valid individual TAs associated with the first subset of candidate cells, or any combination thereof. The operations of 1525 may be performed in accordance with examples as disclosed herein. In some examples, aspects of the operations of 1525 may be performed by an invalidity reporting component 1045 as described with reference to FIG. 10.

The following provides an overview of aspects of the present disclosure:

### Aspect 1

A method for wireless communications at a UE, comprising: receiving, from a serving cell, control signaling indicating a C-TAG comprising a plurality of candidate cells; receiving, from the serving cell, a downlink control message comprising a command to initiate access with a candidate cell of the set of multiple candidate cells of the C-TAG; transmitting, to the candidate cell, a RACH message based at least in part on the command to initiate access with the candidate cell; obtaining a common TA associated with the C-TAG based at least in part on transmitting the RACH message; and communicating with at least one candidate cell of the plurality of candidate cells of the C-TAG based at least in part on the common TA.

### Aspect 2

The method of aspect 1, wherein obtaining the common TA comprises: receiving, from the serving cell, second control signaling indicating the common TA associated with the C-TAG based at least in part on the candidate cell being associated with the C-TAG.

### Aspect 3

The method of aspect 2, further comprising: resetting a validation timer associated with the common TA based at least in part on receiving the second control signaling.

### Aspect 4

The method of any of aspects 1 through 3, wherein obtaining the common TA comprises: determining the common TA based at least in part on one or more TAs associated with one or more candidate cells of the C-TAG.

### Aspect 5

The method of any of aspects 1 through 4, wherein obtaining the common TA comprises: measuring an individual TA associated with the candidate cell, wherein the common TA is based at least in part on the individual TA associated with the candidate cell.

### Aspect 6

The method of any of aspects 1 through 5, wherein the control signaling indicating the C-TAG further indicates a C-TAG identifier, candidate cell identifiers of the plurality of candidate cells, one or more RSRP change thresholds for evaluating a validity of the common TA, one or more validation timers associated with the common TA, or any combination thereof.

### Aspect 7

The method of aspect 6, wherein the one or more validation timers comprise a single validation timer associated with the plurality of candidate cells, or a plurality of validation timers, each validation timer of the plurality of validation timers associated with one or more respective candidate cells of the plurality of candidate cells.

### Aspect 8

The method of any of aspects 1 through 7, further comprising: performing measurements for reference signals received via one or more candidate cells of the plurality of candidate cells; and determining a validity of the common TA based at least in part on a comparison between the measurements and one or more RSRP change thresholds associated with the C-TAG, wherein communicating with the at least one candidate cell is based at least in part on the validity of the common TA.

### Aspect 9

The method of aspect 8, wherein the one or more RSRP change thresholds comprise a single RSRP change threshold associated with the plurality of candidate cells, or a plurality of RSRP thresholds, each RSRP threshold of the plurality of RSRP thresholds associated with one or more respective candidate cells of the plurality of candidate cells.

### Aspect 10

The method of any of aspects 8 through 9, wherein the one or more RSRP change thresholds are associated with a reference candidate cell of the plurality of candidate cells.

### Aspect 11

The method of any of aspects 1 through 10, further comprising: determining one or more validities of one or more individual TAs associated with one or more candidate cells of the C-TAG based at least in part on expiration of a validation timer associated with the common TA, measurements of reference signals received from one or more candidate cells exceeding a measurement change threshold, or both; and determining a validity of the common TA based at least in part on the one or more validities of the one or more individual TAs satisfying a threshold.

### Aspect 12

The method of any of aspects 1 through 11, further comprising: determining an invalidity of the common TA; and transmitting, to the serving cell, a report indicating the invalidity of the common TA, wherein the report comprises a C-TAG identifier, an indication of a first subset of candidate cells of the plurality of candidate cells that are associated with valid individual TAs, an indication of a second subset of candidate cells of the plurality of candidate cells that are associated with invalid individual TAs, an indication of the valid individual TAs associated with the first subset of candidate cells, or any combination thereof.

### Aspect 13

The method of aspect 12, wherein the report is transmitted based at least in part on a timer at the UE.

### Aspect 14

The method of any of aspects 1 through 13, wherein the RACH message is transmitted based at least in part on an expiration of a prohibit timer.

### Aspect 15

The method of any of aspects 1 through 14, wherein the RACH message comprises a C-TAG identifier of the C-TAG, a candidate cell identifier of the candidate cell, a synchronization signal block index, or any combination thereof.

### Aspect 16

The method of any of aspects 1 through 15, wherein the control signaling indicating the C-TAG comprises an RRC message, a MAC-CE, or both.

### Aspect 17

A method for wireless communications at a serving cell, comprising: outputting, to a UE, control signaling indicating a C-TAG comprising a plurality of candidate cells; outputting, to the UE, a downlink control message comprising a command to initiate access with a candidate cell of the set of multiple candidate cells of the C-TAG; obtaining, from the candidate cell of the C-TAG, a report comprising an indication of a common TA; and outputting, to the UE, the common TA associated with the C-TAG based at least in part on obtaining the report.

### Aspect 18

The method of aspect 17, wherein the control signaling indicating the C-TAG further indicates a C-TAG identifier, candidate cell identifiers of the plurality of candidate cells, one or more RSRP change thresholds for evaluating a validity of the common TA, one or more validation timers associated with the common TA, or any combination thereof.

### Aspect 19

The method of aspect 18, wherein the one or more validation timers comprise a single validation timer associated with the plurality of candidate cells, or a plurality of validation timers, each validation timer of the plurality of validation timers associated with one or more respective candidate cells of the plurality of candidate cells.

### Aspect 20

The method of any of aspects 18 through 19, wherein the one or more RSRP change thresholds comprise a single RSRP change threshold associated with the plurality of candidate cells, or a plurality of RSRP thresholds, each RSRP threshold of the plurality of RSRP thresholds associated with one or more respective candidate cells of the plurality of candidate cells.

### Aspect 21

The method of any of aspects 18 through 20, wherein the one or more RSRP change thresholds are associated with a reference candidate cell of the plurality of candidate cells.

### Aspect 22

The method of any of aspects 17 through 21, further comprising: obtaining, from the UE, a second report indicating an invalidity of the common TA, wherein the second report comprises a C-TAG identifier, an indication of a first subset of candidate cells of the plurality of candidate cells that are associated with valid individual TAs, an indication of a second subset of candidate cells of the plurality of candidate cells that are associated with invalid individual TAs, an indication of the valid individual TAs associated with the first subset of candidate cells, or any combination thereof.

### Aspect 23

The method of any of aspects 17 through 22, wherein the control signaling indicating the C-TAG comprises an RRC message, a MAC-CE, or both.

### Aspect 24

A UE for wireless communications, comprising one or more memories storing processor-executable code, and one or more processors coupled with the one or more memories and individually or collectively operable to execute the code to cause the UE to perform a method of any of aspects 1 through 16.

### Aspect 25

A UE for wireless communications, comprising at least one means for performing a method of any of aspects 1 through 16.

### Aspect 26

A non-transitory computer-readable medium storing code for wireless communications, the code comprising instructions executable by one or more processors to perform a method of any of aspects 1 through 16.

### Aspect 27

A serving cell for wireless communications, comprising one or more memories storing processor-executable code, and one or more processors coupled with the one or more memories and individually or collectively operable to execute the code to cause the serving cell to perform a method of any of aspects 17 through 23.

### Aspect 28

A serving cell for wireless communications, comprising at least one means for performing a method of any of aspects 17 through 23.

### Aspect 29

A non-transitory computer-readable medium storing code for wireless communications, the code comprising instructions executable by one or more processors to perform a method of any of aspects 17 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a serving cell, control signaling indicating a candidate cell timing advance group comprising a plurality of candidate cells;
receive, from the serving cell, a downlink control message comprising a command to initiate access with a candidate cell of the plurality of candidate cells of the candidate cell timing advance group;
transmit, to the candidate cell, a random access channel message based at least in part on the command to initiate access with the candidate cell;
obtain a common timing advance associated with the candidate cell timing advance group based at least in part on transmitting the random access channel message; and
communicate with at least one candidate cell of the plurality of candidate cells of the candidate cell timing advance group based at least in part on the common timing advance.

2. The UE of claim 1, wherein, to obtain the common timing advance, the one or more processors are individually or collectively operable to execute the code to cause the UE to:
receive, from the serving cell, second control signaling indicating the common timing advance associated with the candidate cell timing advance group based at least in part on the candidate cell being associated with the candidate cell timing advance group.

3. The UE of claim 2, wherein the one or more processors are individually or collectively further operable to execute the code to cause the UE to:
reset a validation timer associated with the common timing advance based at least in part on receiving the second control signaling.

4. The UE of claim 1, wherein, to obtain the common timing advance, the one or more processors are individually or collectively operable to execute the code to cause the UE to:
determine the common timing advance based at least in part on one or more timing advances associated with one or more candidate cells of the candidate cell timing advance group.

5. The UE of claim 1, wherein, to obtain the common timing advance, the one or more processors are individually or collectively operable to execute the code to cause the UE to:
measure an individual timing advance associated with the candidate cell, wherein the common timing advance is based at least in part on the individual timing advance associated with the candidate cell.

6. The UE of claim 1, wherein the control signaling indicating the candidate cell timing advance group further indicates a candidate cell timing advance group identifier, candidate cell identifiers of the plurality of candidate cells, one or more reference signal received power change thresholds for evaluating a validity of the common timing advance, one or more validation timers associated with the common timing advance, or any combination thereof.

7. The UE of claim 6, wherein the one or more validation timers comprise:
a single validation timer associated with the plurality of candidate cells, or
a plurality of validation timers, each validation timer of the plurality of validation timers associated with one or more respective candidate cells of the plurality of candidate cells.

8. The UE of claim 1, wherein the one or more processors are individually or collectively further operable to execute the code to cause the UE to:
perform measurements for reference signals received via one or more candidate cells of the plurality of candidate cells; and
determine a validity of the common timing advance based at least in part on a comparison between the measurements and one or more reference signal received power change thresholds associated with the candidate cell timing advance group, wherein communicating with the at least one candidate cell is based at least in part on the validity of the common timing advance.

9. The UE of claim 8, wherein the one or more reference signal received power change thresholds comprise:
a single reference signal received power change threshold associated with the plurality of candidate cells, or
a plurality of reference signal received power thresholds, each reference signal received power threshold of the plurality of reference signal received power thresholds associated with one or more respective candidate cells of the plurality of candidate cells.

10. The UE of claim 8, wherein the one or more reference signal received power change thresholds are associated with a reference candidate cell of the plurality of candidate cells.

11. The UE of claim 1, wherein the one or more processors are individually or collectively further operable to execute the code to cause the UE to:
determine one or more validities of one or more individual timing advances associated with one or more candidate cells of the candidate cell timing advance group based at least in part on expiration of a validation timer associated with the common timing advance, measurements of reference signals received from one or more candidate cells exceeding a measurement change threshold, or both; and
determine a validity of the common timing advance based at least in part on the one or more validities of the one or more individual timing advances satisfying a threshold.

12. The UE of claim 1, wherein the one or more processors are individually or collectively further operable to execute the code to cause the UE to:
determine an invalidity of the common timing advance; and
transmit, to the serving cell, a report indicating the invalidity of the common timing advance, wherein the report comprises a candidate cell timing advance group identifier, an indication of a first subset of candidate cells of the plurality of candidate cells that are associated with valid individual timing advances, an indication of a second subset of candidate cells of the plurality of candidate cells that are associated with invalid individual timing advances, an indication of the valid individual timing advances associated with the first subset of candidate cells, or any combination thereof.

13. The UE of claim 12, wherein the report is transmitted based at least in part on a timer at the UE.

14. The UE of claim 1, wherein the random access channel message is transmitted based at least in part on an expiration of a prohibit timer.

15. The UE of claim 1, wherein the random access channel message comprises a candidate cell timing advance group identifier of the candidate cell timing advance group, a candidate cell identifier of the candidate cell, a synchronization signal block index, or any combination thereof.

16. The UE of claim 1, wherein the control signaling indicating the candidate cell timing advance group comprises a radio resource control (RRC) message, a medium access control-control element (MAC-CE), or both.

17. A serving cell, comprising:
one or more memories storing processor-executable code; and
one or more processors coupled with the one or more memories and individually or collectively operable to execute the code to cause the serving cell to:
output, to a user equipment (UE), control signaling indicating a candidate cell timing advance group comprising a plurality of candidate cells;
output, to the UE, a downlink control message comprising a command to initiate access with a candidate cell of the plurality of candidate cells of the candidate cell timing advance group;
obtain, from the candidate cell of the candidate cell timing advance group, a report comprising an indication of a common timing advance; and
output, to the UE, the common timing advance associated with the candidate cell timing advance group based at least in part on obtaining the report.

18. The serving cell of claim 17, wherein the control signaling indicating the candidate cell timing advance group further indicates a candidate cell timing advance group identifier, candidate cell identifiers of the plurality of candidate cells, one or more reference signal received power change thresholds for evaluating a validity of the common timing advance, one or more validation timers associated with the common timing advance, or any combination thereof.

19. The serving cell of claim 18, wherein the one or more validation timers comprise:
a single validation timer associated with the plurality of candidate cells, or
a plurality of validation timers, each validation timer of the plurality of validation timers associated with one or more respective candidate cells of the plurality of candidate cells.

20. A method for wireless communications at a user equipment (UE), comprising:
receiving, from a serving cell, control signaling indicating a candidate cell timing advance group comprising a plurality of candidate cells;
receiving, from the serving cell, a downlink control message comprising a command to initiate access with a candidate cell of the plurality of candidate cells of the candidate cell timing advance group;
transmitting, to the candidate cell, a random access channel message based at least in part on the command to initiate access with the candidate cell;
obtaining a common timing advance associated with the candidate cell timing advance group based at least in part on transmitting the random access channel message; and
communicating with at least one candidate cell of the plurality of candidate cells of the candidate cell timing advance group based at least in part on the common timing advance.
